(19) United States
(12) Patent Application Publication
(10) Pub. No.: US 2004/0061671 A1
(43) Pub. Date: Apr. 1, 2004

(54) Display apparatus driven by DC current

(75) Inventors: Masahiro Kawasaki, Tokyo (JP); Yoshirou Mikami, Tokyo (JP); Hajime Murakami, Tokyo (JP); Masahiko Andou, Tokyo (JP); Kenichi Onisawa, Tokyo (JP); Akitoyo Konno, Tokyo (JP)

Correspondence Address: CROWELL & MORING LLP, INTELLECTUAL PROPERTY GROUP, P.O. BOX 14300, WASHINGTON, DC, 20044-4300, US

(73) Assignee: Hitachi Displays, Ltd.

(21) Appl. No.: 10/640,675

(22) Filed: Aug. 14, 2003

(30) Foreign Application Priority Data
Sep. 30, 2002 (JP) 2002-284711

(51) Int. Cl. G09G 3/30

(52) U.S. Cl. 345/76

(57) ABSTRACT

A display apparatus is arranged in a manner that each pixel includes a light emitting element for emitting light in response to a current flowing therein, a first switching element for fetching luminance information into a pixel from a signal line, and a second switching element for controlling a current amount to be supplied to the light emitting element in accordance with the luminance information thus fetched; the luminance information is fetched by fetching the signal voltage of the signal line when a scanning line connected to the pixel is selected; and the luminance information thus fetched in each of the pixels is kept in a capacitor even after the scanning line connected to the pixel is place in a non-selection state. A predetermined one cycle until next new luminance information is taken into a pixel after luminance information was taken into the pixel is formed by a pixel turn-on time period and a threshold value control time period for applying a threshold value control voltage having an opposite polarity to that of a signal voltage as the luminance information to the gate electrode of the second switching element.

### BACKGROUND OF THE INVENTION

1. Field of the Invention

The present invention relates to a display apparatus driven by DC current using an organic electro-luminescent element etc.

2. Description of the Related Art

A display apparatus using an organic electro-luminescent element of a self-luminous type (hereinafter referred as an organic EL element) is not required to provide a backlight as compared with a non-luminous type such as a liquid crystal. Thus, the organic EL element has a feature that it is thin, light-weight and high in its responsive speed and so suitable for displaying a moving picture.

FIG. 2 shows an equivalent circuit of one pixel of the conventional organic EL element apparatus. One pixel PX is configured by an organic EL element, at least two switching elements formed by a switching element Tr1 for taking luminance information into the pixel and a switching element Tr2 for controlling an amount of current supplied to the organic EL element in accordance with the luminance information thus taken, and a holding capacitor C1.

When a scanning line coupled to the pixel is selected, a signal voltage Vs as the luminance information of the pixel is taken from a data line by the switching element Tr1 for taking the luminance information into the pixel. The signal voltage Vs thus taken is held by the holding capacitor C1 even when the scanning line is not selected and so applied to the gate electrode of the switching element Tr2 for controlling an amount of current supplied to the organic EL element. Since the anode of the organic EL element is coupled to a power source Va, a DC current depending on the voltage between the gate electrode and the source electrode of the switching element Tr2 flows into the organic EL element to turn the pixel on.

As disclosed in JP-A-2001-60076, at the time of displaying a moving picture on the display apparatus, there arises a case that each of the luminance elements may be changed from a turn-on (lit or lighting) state to a turn-off (extinguished or lights-out) state during one scanning cycle until next new luminance information is written into the respective pixels after luminance information was written into the respective pixels.

In order to emit light from the organic EL element efficiently and stably, in general a polycrystalline silicon thin-film transistor which has a high mobility (10 to 100 cm2/Vs) and is high in stability of a threshold value is used for each of the switching elements Tr1 and Tr 2.

### SUMMARY OF THE INVENTION

In the case where, for example, an amorphous silicon thin film transistor or an organic thin film transistor which is cheap and capable of forming a large screen is used as the switching element of the pixel of the conventional display apparatus, when the display apparatus is turned on for a long time, the threshold voltage shift occurs particularly at the switching element Tr2 which is always turned on during the turning-on of the pixel. Thus, there arises a problem that the luminance of the organic EL element is degraded due to the threshold voltage shift.

An object of the present invention is to prevent the degradation of the luminance of a switching element for controlling an amount of current supplied to an organic EL element in a display apparatus driven by DC current for driving pixels by DC current.

According to an aspect of the present invention, in a display apparatus driven by DC current in which signal lines for applying luminance information to each of pixels, scanning lines for selecting the pixels to be applied with the luminance information are disposed in an matrix pattern; each of the pixels includes a light emitting element for emitting light in response to a current flowing therein, a first switching element for fetching the luminance information into corresponding one of the pixels from corresponding one of the signal lines, and a second switching element for controlling a current amount to be supplied to corresponding one of the light emitting elements in accordance with the luminance information thus fetched; the luminance information is fetched into each of the pixels by fetching a signal voltage of corresponding one of the signal lines when corresponding one of the scanning lines connected to the pixel is selected; and the luminance information thus fetched in each of the pixels is kept in corresponding one of capacitors even after the corresponding one of the scanning lines connected to the pixel is place in a non-selection state, wherein

a predetermined one cycle until next new luminance information is taken into each of the pixels after luminance information was taken into the pixel is formed by a pixel turn-on time period and a threshold value control time period for applying a threshold value control voltage having an opposite polarity to that of a signal voltage as the luminance information to the gate electrode of the corresponding one of the second switching elements.

Further, the threshold value control voltage applied to the gate electrode of each of the second switching elements is fetched through the corresponding one of the first switching elements from the corresponding one of the signal lines.

Further, each of the pixels further includes a third switching element, and the threshold value control voltage applied to the gate electrode of each of the second switching elements is fetched through the corresponding one of the third switching elements from the corresponding one of the signal lines.

Further, the display apparatus driven by DC current further includes two image memories.

Further, the threshold value control voltage applied to the gate electrode of each of the second switching elements is obtained by inverting polarity of the signal voltage of the same cycle.

Further, the threshold value control voltage applied to the gate electrode of each of the second switching elements is same for each of the pixels.

Further, the threshold value control time period for applying the threshold value control voltage to the gate electrode of each of the second switching elements is about a half of the predetermined cycle until next new luminance information is taken into corresponding one of the pixels after luminance information was taken into the corresponding one of the pixels.

Further, during the time period for applying the threshold value control voltage to the gate electrode of each of the second switching elements, corresponding one of the first switching elements is placed in an always on state.

Further, a semiconductor layer of each of the second switching elements is formed by amorphous silicon.

Further, a semiconductor layer of each of the second switching elements is formed by organic.

Further, each of the light emitting elements is an organic eelectroluminesence element.

According to an aspect of the present invention, in a display apparatus driven by DC current in which signal lines for applying luminance information to each of pixels, scanning lines for selecting the pixels to be applied with the luminance information are disposed in an matrix pattern; each of the pixels includes a light emitting element for emitting light in response to a current flowing therein, a first switching element for fetching the luminance information into corresponding one of the pixels from corresponding one of the signal lines, and a second switching element for controlling a current amount to be supplied to corresponding one of the light emitting elements in accordance with the luminance information thus fetched; the luminance information is fetched into each of the pixels by fetching a signal voltage of corresponding one of the signal lines when corresponding one of the scanning lines connected to the pixel is selected; and the luminance information thus fetched in each of the pixels is kept in corresponding one of capacitors even after the corresponding one of the scanning lines connected to the pixel is place in a non-selection state, wherein

a predetermined one cycle until next new luminance information is taken into each of the pixels after luminance information was taken into the pixel is formed by a pixel turn-on time period and a time period for applying to corresponding one of the light emitting elements electric field with opposite polarity to electric field applied during the pixel turn-on time period and also for applying a threshold value control voltage having an opposite polarity to that of a signal voltage as the luminance information to the gate electrode of the corresponding one of the second switching elements.

Further, the threshold value control voltage applied to the gate electrode of each of the second switching elements is fetched through the corresponding one of the first switching elements from the corresponding one of the signal lines.

Further, each of the pixels further includes a third switching element, and the threshold value control voltage applied to the gate electrode of each of the second switching elements is fetched through the corresponding one of the third switching elements from the corresponding one of the signal lines.

Further, the display apparatus driven by DC current further includes two image memories.

Further, the threshold value control voltage applied to the gate electrode of each of the second switching elements is obtained by inverting polarity of the signal voltage of the same cycle.

Further, the threshold value control voltage applied to the gate electrode of each of the second switching elements is same for each of the pixels.

Further, the threshold value control time period for applying the threshold value control voltage to the gate electrode of each of the second switching elements is about a half of the predetermined cycle until next new luminance information is taken into corresponding one of the pixels after luminance information was taken into the corresponding one of the pixels.

Further, during the time period for applying the threshold value control voltage to the gate electrode of each of the second switching elements, corresponding one of the first switching elements is placed in an always on state.

Further, each of an electric field effect mobility of holes and an electric field effect mobility of electrons in a semiconductor layer of each of the second switching elements is 1×10−2 cm2/Vs or more.

Further, a semiconductor layer of each of the second switching elements includes amorphous silicon, and no n+ contact layer is contained between the semiconductor layer and source and drain electrodes thereof.

Further, a semiconductor layer of each of the first and second switching elements includes amorphous silicon, and a n+ contact layer disposed between the semiconductor layer and source and drain electrodes thereof is thinner in thickness than a n+ contact layer of each of the first switching elements.

Further, a semiconductor layer of each of the second switching elements is formed by organic.

Further, each of the light emitting elements is an organic electroluminesence element.

According to an aspect of the present invention, in a display apparatus driven by DC current in which signal lines for applying luminance information to each of pixels, scanning lines for selecting the pixels to be applied with the luminance information are disposed in an matrix pattern; each of the pixels includes a light emitting element for emitting light in response to a current flowing therein, a first switching element for fetching the luminance information into corresponding one of the pixels from corresponding one of the signal lines, and a second switching element for controlling a current amount to be supplied to corresponding one of the light emitting elements in accordance with the luminance information thus fetched; the luminance information is fetched into each of the pixels by fetching a signal voltage of corresponding one of the signal lines when corresponding one of the scanning lines connected to the pixel is selected; and the luminance information thus fetched in each of the pixels is kept in corresponding one of capacitors even after the corresponding one of the scanning lines connected to the pixel is place in a non-selection state, wherein

a signal voltage as the luminance information to be fetched into each of the pixels differs in its polarity at every cycle.

Further, during the one cycle until next new luminance information is taken into each of the pixels after luminance information was taken into the pixel, a time period for turning off corresponding one of the second switching elements thereby to turn off corresponding one of the pixels.

Further, a signal for turning each of the second switching elements off is taken through corresponding one of the first switching elements from corresponding one of the signal lines.

Further, each of the pixels includes a third switching element, and a signal for turning each of the second switching elements off is taken through corresponding one of the third switching elements.

Further, during the one cycle until next new luminance information is taken into each of the pixels after luminance information was taken into the pixel, a time period for turning off corresponding one of the second switching elements thereby to turn off corresponding one of the pixels.

Further, each of the second switching elements is placed in an on state during a time period where corresponding one of the pixels in turned off.

Further, each of the first switching elements is placed in an always on state during a time period where corresponding one of the pixels in turned off.

Further, each of an electric field effect mobility of holes and an electric field effect mobility of electrons in a semiconductor layer of each of the second switching elements is same in its order.

Further, each of an electric field effect mobility of holes and an electric field effect mobility of electrons in a semiconductor layer of each of the second switching elements is 1×10⁻² cm²/Vs or more.

Further, a semiconductor layer of each of the second switching elements includes amorphous silicon, and no n⁺ contact layer is contained between the semiconductor layer and source and drain electrodes thereof.

Further, a semiconductor layer of each of the first and second switching elements includes amorphous silicon, and a n⁺ contact layer disposed between the semiconductor layer and source and drain electrodes thereof is thinner in thickness than a n+ contact layer of each of the first switching elements.

Further, a semiconductor layer of each of the second switching elements is formed by organic.

Further, a semiconductor layer of each of the second switching elements is formed by smectic liquid crystal of organic compound.

Further, each of the light emitting elements is an organic electroluminesence element.

According to the present invention, the display apparatus driven by DC current with a large screen, in which the threshold value shift of the switching element for a pixel is controlled and an amorphous silicon thin film transistor and an organic thin film transistor is used as the switching element for a pixel, can be provided at a low cost.

### BRIEF DESCRIPTION OF THE DRAWINGS

FIG. 1 shows driving voltage waveforms of the display apparatus according to the present invention;

FIG. 2 shows .an example of the equivalent circuit of the pixel portion of the display apparatus according to the present invention;

FIG. 3 shows an example of the entire system configuration of the display apparatus according to the present invention;

FIG. 4 shows an example of the switching element of the pixel portion of the display apparatus according to the present invention;

FIG. 5 shows electric characteristics of the switching element used as an example at the pixel portion of the display apparatus according to the present invention;

FIG. 6 shows the +20 volt gate-voltage applying time dependency characteristics with respect to the threshold value shift amount of the switching element used as an example at the pixel portion of the display apparatus according to the present invention;

FIG. 7 shows the −20 volt gate-voltage applying time dependency characteristics with respect to the threshold value shift amount of the switching element used as an example at the pixel portion of the display apparatus according to the present invention;

FIG. 8 shows the gate voltage dependency characteristics with respect to the threshold value shift amount of the switching element used as an example at the pixel portion of the display apparatus according to the present invention;

FIG. 9 shows driving voltage waveforms of the display apparatus according to the present invention;

FIG. 10 shows driving voltage waveforms of the display apparatus according to the present invention;

FIG. 11 shows an example of the equivalent circuit of the pixel portion of the display apparatus according to the present invention;

FIG. 12 shows an example of the entire system configuration of the display apparatus according to the present invention;

FIG. 13 shows driving voltage waveforms of the display apparatus according to the present invention;

FIG. 14 shows an example of the light emitting element used in the display apparatus according to the present invention;

FIG. 15 shows electric characteristics of the switching element used as an example at the pixel portion of the display apparatus according to the present invention;

FIG. 16 shows driving voltage waveforms of the display apparatus according to the present invention;

FIG. 17 shows an example of the entire system configuration of the display apparatus according to the present invention;

FIG. 18 shows driving voltage waveforms of the display apparatus according to the present invention; and

FIG. 19 shows an example of the entire system configuration of the display apparatus according to the present invention.

### DETAILED DESCRIPTION OF THE INVENTION

Embodiments of a display apparatus driven by DC current according to the present invention will be explained with reference to accompanying drawings.

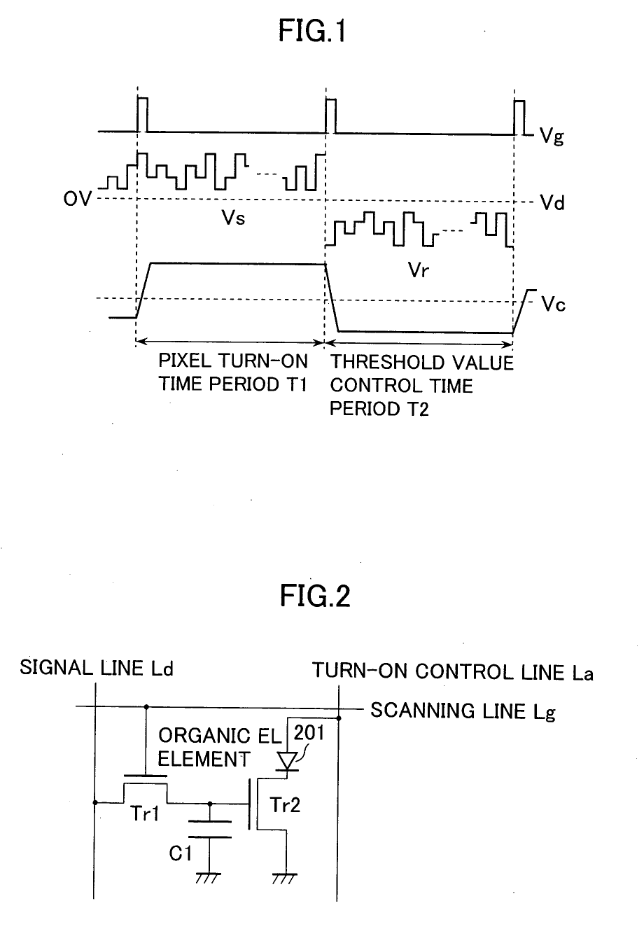

The first embodiment of the display apparatus driven by DC current according to the present invention will be explained with reference to FIGS. 1 to 8. FIG. 1 shows voltage waveforms at respective wirings at the time of driving the display apparatus. A predetermined one cycle until next new luminance information is taken into a pixel after luminance information was taken into the pixel is formed by a pixel turn-on time period T1 and a threshold value control time period T2 for applying a threshold value control voltage Vr having an opposite polarity to that of a signal voltage Vs as the luminance information to the gate electrode of a second switching element. The signal voltage Vs as the luminance information is taken from a signal line during the pixel turn-on time period T1, and the threshold value control voltage Vr having the opposite polarity to that of the luminance information is taken from the signal line during the threshold value control time period T2. The signal voltage Vs as the luminance information and the threshold value control voltage Vr are line-symmetry with respect to the 0 volt line of the signal line voltage to each other. An example of the equivalent circuit of one pixel of the display apparatus shown in FIG. 2 is same as the conventional example. One pixel is configured by an organic EL element 201, at least two switching elements formed by a switching element Tr1 for taking the luminance information into the pixel and a switching element Tr2 for controlling an amount of current supplied to the organic EL element 201 in accordance with the luminance information thus taken, and a holding capacitor C1. The gate electrode of the switching element Tr1 is connected to a scanning line Lg, the drain electrode thereof is connected to an image signal line Ld and the source electrode thereof is connected to the gate electrode of the switching element Tr2 and one end of the holding capacitor C1. The source electrode of the switching element Tr2 is grounded and the drain electrode thereof is connected to the cathode of the organic EL element 201. In FIG. 2, although the one end of the holding capacitor C1 is grounded, the one end thereof may be connected to a turn-on control line La. The anode of the organic EL element is connected to the turn-on control line La and so applied with a constant voltage Va from a turn-on control power source.

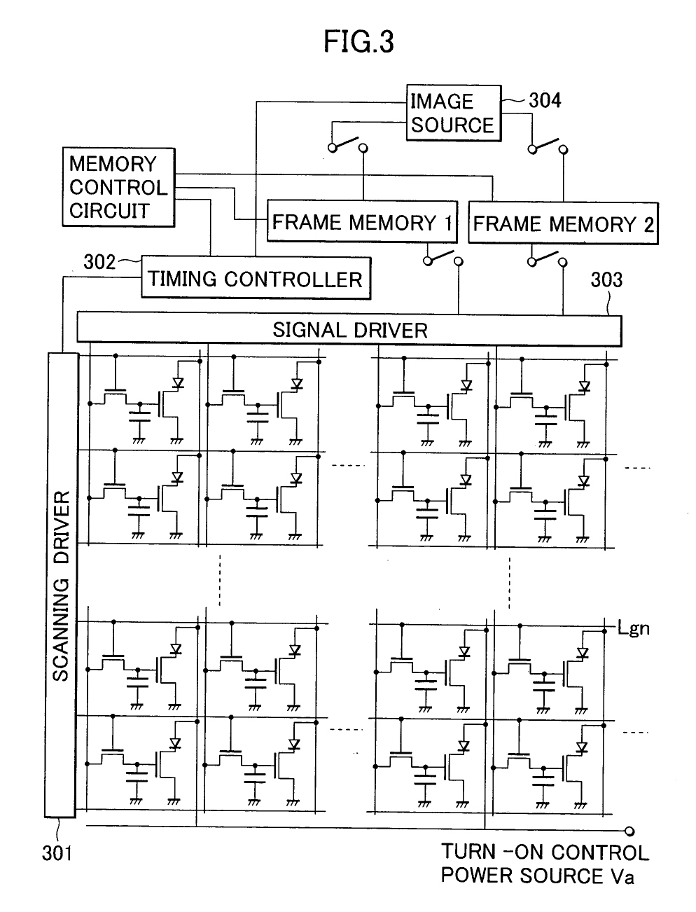

FIG. 3 shows an example of the entire system configuration of the display apparatus. In this system, the pixels disposed in rows and columns, the scanning lines Lg for selecting the pixels in the predetermined cycle and the signal lines Ld for applying the luminance information to the pixels are disposed in an matrix pattern. Each of the scanning line Lg is connected to a scanning driver 301 and a timing controller 302 is connected to the scanning driver 301. Each of the signal lines Ld is connected to a signal driver 303. The image information is taken from an image source 304 to a frame memory 1 for display and a frame memory 2 for controlling a threshold value, and the information thus taken into these memories is alternatively applied to the signal driver 303.

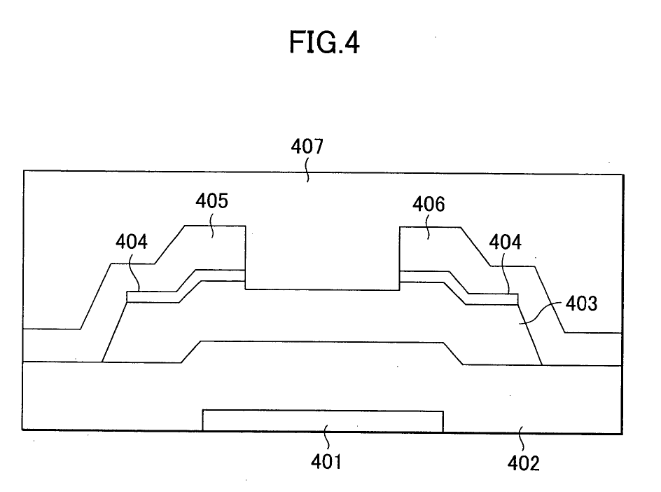

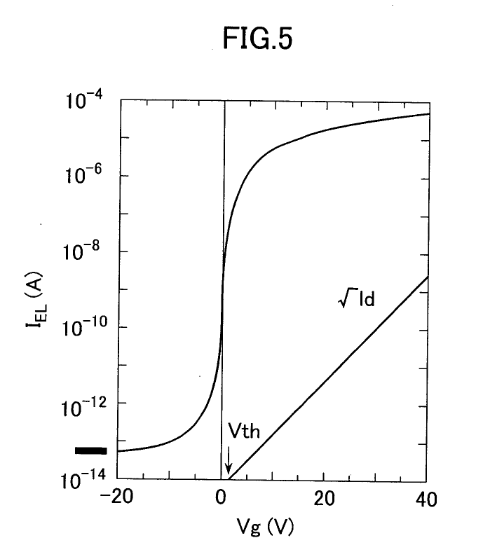

For example, the pixel of the m-th row and the n-th column is operated during one cycle in the following manner. When the scanning line Lgn of the n-th column connected to the pixel is selected, the corresponding switching element Tr1 is applied at its gate electrode with a predetermined voltage and so placed in an on state. At this time, the signal voltage Vs=Vdmn as the luminance information is taken from the signal line through the switching element Tr1 and then applied to the gate electrode of the switching element Tr2. Even after the scanning line Lgn of the n-th column connected to the pixel is placed in a non-selection state, the luminance information thus taken is accumulated in the holding capacitor C1 of the pixel, so that the signal voltage Vs=Vc is kept to be applied for a predetermined period to the gate electrode of the corresponding switching element Tr2, whereby the organic EL element is kept to illuminate. An amorphous silicon (a-Si) thin film transistor, for example, is used as each of the switching elements Tr2. FIG. 4 shows a sectional diagram of the a-Si thin film transistor. The a-Si thin film transistor is configured in a manner that a gate electrode 401 (Cr of 100 nm), a gate insulation film 402 (SiN of 300 nm), a semiconductor layer 403 (a-Si of 100 nm), a contact layer 404 (n+ a-Si of 30 nm), a drain electrode 405, a source electrode 406 (Cr of 100 nm), and a protection insulation film 407 (SiN of 500 nm) are sequentially laminated on an insulation substrate. FIG. 5 shows switching characteristics of the switching element Tr2 to which the constant voltage 5V of the anode voltage of the organic EL element is applied. In the figure, an ordinate represents a current I_{EL} flowing into the organic EL element and an abscissa represents a gate electrode voltage Vg. An amount of the current flowing into the organic EL element is determined by the gate voltage of the switching element Tr2. Since the luminance of the light emitted from the organic EL element is proportional to the current flowing therein, the luminance of the pixel is determined by the gate voltage of the switching element Tr2.

The signal voltage of a positive polarity is applied to the gage electrode of the switching element Tr2 during the pixel turn-on time period T1. At this time, the threshold value Vth of the switching element Tr2 shifts to the direction of the same polarity as the gate electrode voltage Vg and the current I_{EL} flowing into the organic EL element reduces, so that there arises a problem that the luminance of the pixel also reduces. The threshold value Vth can be defined as an intersection point where a linear line formed by plotting ½ squares of the current values flowing into the organic EL element with respect to the gate electrode voltage Vg intersects with the axis of the gate electrode voltage (abscissa). The main cause of the threshold voltage shift is electric charges injected into the gate insulation film. When the positive voltage is applied to the gate electrode 401 of the a-Si thin film transistor, the electron density at the boundary surface between the a-Si semiconductor layer 403 and the gate insulation film 402 increases and so a current path is formed at the boundary surface. At this time, with the increase of the time period during which the positive voltage is applied to the gate electrode 401, the electrons at the boundary surface between the a-Si semiconductor layer 403 and the gate insulation film 402 are injected into the gate insulation film 402.

Next, when the scanning line Lgn of the n-th column connected to the pixel is selected again, the corresponding switching element Tr1 is applied at its gate electrode with the predetermined voltage and so placed in the on state. At this time, the threshold value control voltage Vr=Vdmn′ of the negative polarity is taken from the signal line through the switching element Tr1 and then applied to the gate electrode 401 of the switching element Tr2. Even after the scanning line Lgn of the n-th column connected to the pixel is placed in the non-selection state, the information thus taken is accumulated in the holding capacitor C1 of the pixel, so that the threshold value control voltage Vr is kept to be applied for the predetermined period to the gate electrode of the corresponding switching element Tr2. When the voltage of the negative polarity is applied to the gate electrode 401, the hole density at the boundary surface between the a-Si semiconductor layer 403 and the gate insulation film 402 increases, and so the holes are injected into the gate insulation film 402 with the increase of the applied time period of the voltage of the negative polarity. During the threshold value control time period T2, the threshold value Vth of the switching element Tr2 shifts to the direction of the same polarity as the gate electrode voltage Vg, so that the threshold value shift during the pixel turn-on time period T1 can be canceled.

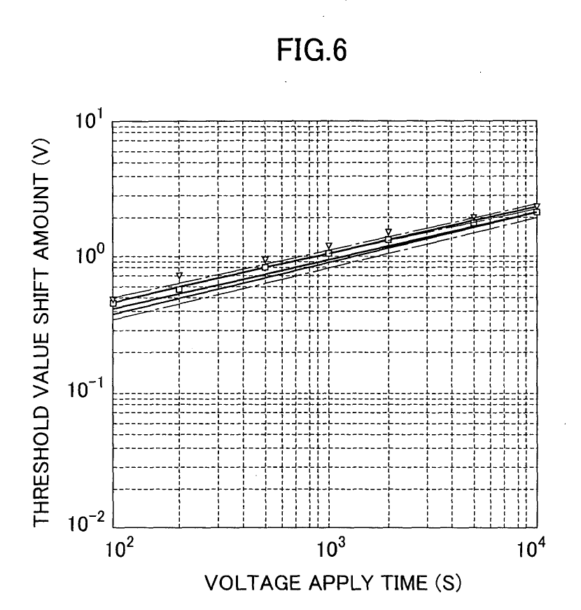

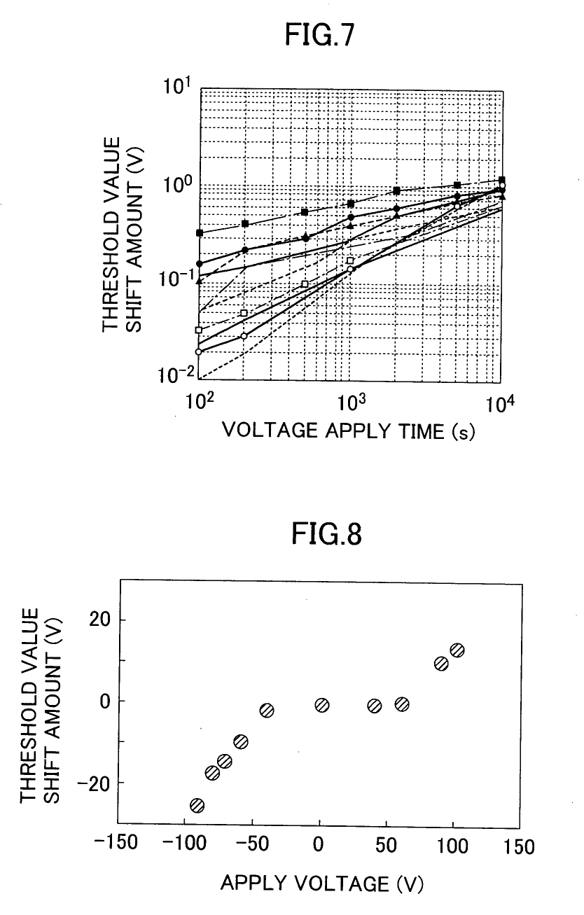

FIG. 6 shows the voltage apply time-period dependency of the threshold value shift amount in the case where the voltage of +20 volt is applied to the gate electrode 401 of the a-Si thin film transistor. FIG. 7 shows the voltage apply time-period dependency of the threshold value shift amount in the case where the voltage of −20 volt is applied to the gate electrode 401 of the a-Si thin film transistor. In each of FIGS. 7 and 8, measured values are plotted as to ten samples which differ in film forming conditions of the gate insulation film 402 and the a-Si semiconductor layer 403. The threshold value shift amount is almost in a range of +0.8 volt to 1 volt when the voltage of +20 volt is applied during 10³ seconds, and the threshold value shift amount is almost in a range of −0.1 volt to 0.7 volt when the voltage of −20 volt is applied during 10³ seconds. In contrast, the threshold value shift amount is almost 1.1 volt when the voltage of +20 volt is applied during 10⁴ seconds, and the threshold value shift amount is almost in a range of −0.5 volt to 1 volt when the voltage of −20 volt is applied during 10⁴ seconds. In this manner, the absolute values of the threshold value shift amounts at the time of applying the voltages of the opposite polarities for the same time period approach to each other with the increase of the voltage applied time period.

The gate voltage dependency of the threshold value shift amount (the gate voltage apply time period is 10 seconds) shown in FIG. 8 is almost symmetric with respect to an origin.

According to the aforesaid facts, it is expected that the threshold value shift of the switching element Tr2 can be suppressed when the voltages of opposite polarities having the same absolute value are alternatively applied to the gate electrode of the switching element Tr2 for the same time period during the one cycle.

In this case, when the threshold value control time period T2 of the switching element Tr2 is set to a half of the predetermined cycle from a time point of fetching the luminance information to a time point of fetching the next new luminance information and the absolute value of the signal voltage Vs is set to be equal to the absolute value of the threshold value control voltage Vr, a time period required for the luminance of the panel decreases by 10% can be improved to about 5×10⁴ hours from the conventional value of about 10² hours. Further, since the threshold value control voltage Vr is set to have inverted values of the signal voltage values of the same cycle with reference to the signal line voltage Vd=0 volt, the threshold value control can be attained in accordance with the threshold value shift amounts different among the respective pixels.

In the case of setting the threshold value control time period T2 of the switching element Tr2 to be longer or shorter than a half of the predetermined cycle from a time point of fetching the luminance information to a time point of fetching the next new luminance information, the adjustment can be performed by the timing controller 302 attached to the scanning driver 301. Further, the threshold value control voltage Vr obtained by inverting the signal voltage Vs with respect to the shaft of the signal line voltage Vd=0 volt can be increased or decreased in its amplitude by the signal driver 303.

Although in this embodiment, the explanation has been made as to an example where the n-type a-Si thin film transistor is used as the switching element Tr2, the present invention is not limited thereto. That is, in the present invention, a p-type thin film transistor may be used as the switching element Tr2. In this case, the voltage of the negative polarity is applied to the gate electrode of the switching element Tr2 during the pixel turn-on time period T1 and the threshold values also shift to the negative side. On the contrary, the voltage of the positive polarity is applied to the gate electrode of the switching element Tr2 during the threshold value control time period T2 and the threshold values also shift to the positive side.

The present invention is more effective when an organic thin film transistor in which electric charges are likely injected is used as the gate insulation film 402 and the protection insulation film 407.

Further, the present invention is also effective when the a-Si thin film transistor which is formed by the CAT CVD and relatively small in the threshold shift amount is used.

Although the aforesaid embodiment is explained as to the case where the line sequential driving system is applied to the present invention, the dot sequential driving system may be applied to the present invention.

Further, although the explanation is made as to an example where the organic EL element is used as the DC current driving element, other type of the DC current driving element may be used in the present invention.

Although it is desirable that the absolute value of the threshold value control voltage Vr is equal to the absolute value of the signal voltage Vs of the same cycle at a pixel, the threshold value control voltage Vr may set to be constant for all the pixels so long as the polarity of the threshold value control voltage Vr is in opposite to the signal voltage Vs.

In the case of displaying an image with monotone, since the signal voltage Vs which is almost the same value for all the pixels is taken, the threshold value control voltage Vr also becomes almost the same value for all the pixels.

(Second Embodiment)

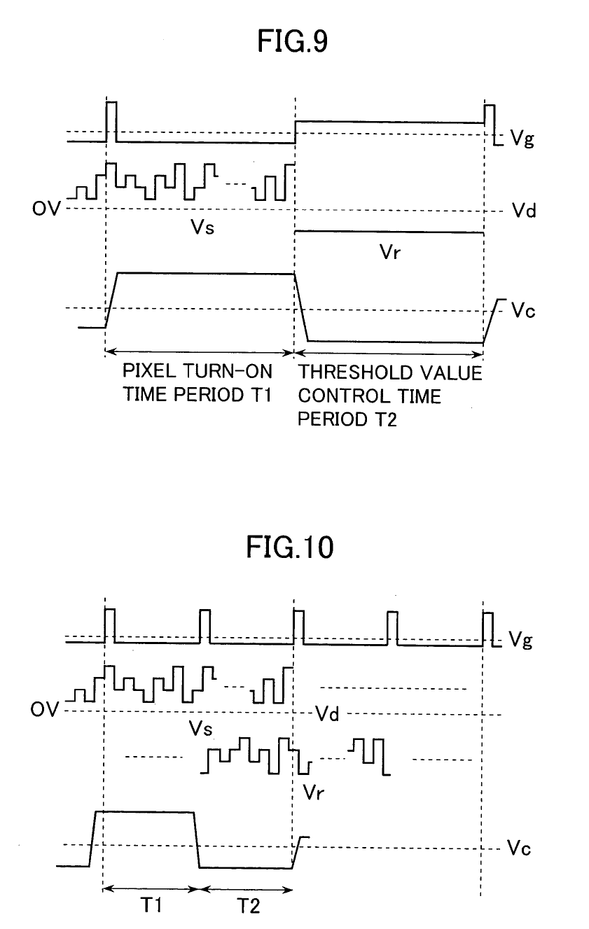

The second embodiment of the present invention will be explained with reference to FIG. 9. The second embodiment differs from the first embodiment in a point that the threshold values of both the switching elements Tr1 and Tr2 are controlled in the threshold value control time period T2. FIG. 9 shows voltage waveforms at respective wirings in this embodiment at the time of driving the display apparatus. A predetermined one cycle until next new luminance information is taken into a pixel after luminance information was taken into the pixel is formed by a pixel turn-on time period T1 and a threshold value control time period T2 for the switching elements Tr1 and Tr2. The signal voltage Vs as the luminance information is taken during the pixel turn-on time period T1, and the threshold value control voltage Vr having the opposite polarity to that of the signal voltage is taken during the threshold value control time period T2. The switching element Tr1 is always placed in an on-state during the threshold value control time period T2.

Like the first embodiment, an a-Si thin film transistor, for example, is used as each of the switching elements Tr1 and Tr2.

For example, the pixel of the m-th row and the n-th column is operated during one cycle in the following manner. When the scanning line Lgn of the n-th column connected to the pixel is selected, the corresponding switching element Tr1 is applied at its gate electrode with a predetermined voltage V_{Lg} and so placed in an on state. At this time, the signal voltage Vs=Vdmn as the luminance information is taken from the signal line through the switching element Tr1. Even after the scanning line Lgn of the n-th column connected to the pixel is placed in a non-selection state, the luminance information thus taken is accumulated in the holding capacitor C1 of the pixel, so that the organic EL element is kept to illuminate.

(Pixel Turn-On Time Period T1)

In the case of driving the display apparatus at 60 Hz, supposing that the total number of the scanning lines is N, it takes such a short time of 1/(60N) seconds to select all of the scanning lines, to apply the predetermined voltage V_{Lg} of the positive polarity to the gate electrodes of the switching elements Tr1, and to place the switching elements Tr1 in an on state. Each of the switching elements Tr1 is placed in an off state during almost of the pixel turn-on time period T1 and the threshold value for applying the negative polarity voltage V_{Lg}′ to the gate electrodes of the switching elements Tr1 shifts to the negative direction. On the other hand, the threshold value of the switching element Tr2, which is applied at its gate electrode with the positive polarity signal voltage Vs=Vdmn and turned on, shifts in the positive direction.

(Threshold Value Control Time Period T2)

Next, the scanning line of the n-th column connected to the pixel is selected again, and the predetermined voltage V_{Lg}″ of the positive polarity is kept to be applied to the gate electrodes of the switching elements Tr1 during the threshold value control time period T2. During this time period, the threshold value control voltage Vr=−Vd of the negative polarity is kept to be applied to the gate electrodes of the switching elements Tr2 from the signal line through the switching elements Tr1 being normally in the on state. During the threshold value control time period T2, the threshold value of the switching elements Tr1 shifts in the positive direction, while the threshold value of the switching elements Tr2 shifts in the negative direction, whereby the threshold value shift of the switching elements Tr1 and Tr2 caused during the pixel turn-on time period can be restored in the original direction.

In order to almost cancel the threshold value shift amount between the pixel turn-on time period T1 and the threshold value control time period T2, it is desirable to set the voltage V_{Lg}′ to be almost same as the voltage V_{Lg}″. In this embodiment, the threshold value control voltage becomes constant at all the pixels.

(Third Embodiment)

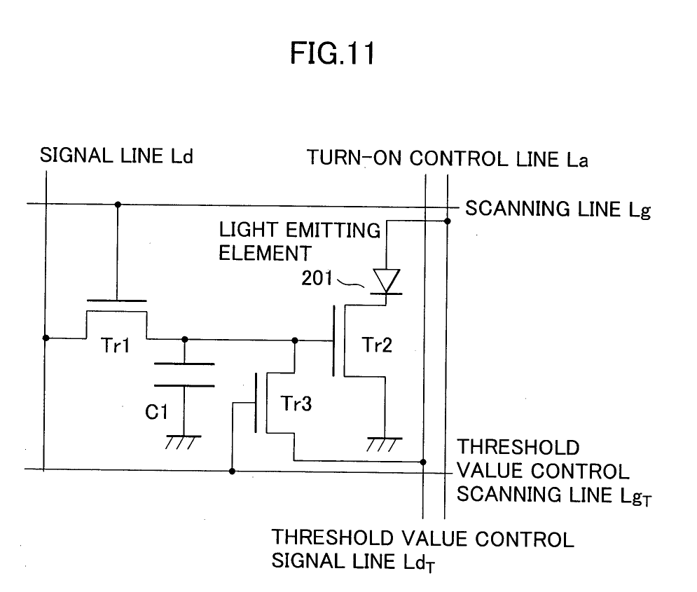

The third embodiment of the present invention will be explained with reference to FIGS. 10 to 12. FIG. 10 shows voltage waveforms at respective wirings in this embodiment at the time of driving the display apparatus. Like the first embodiment, a predetermined one cycle until next new luminance information is taken into a pixel after luminance information was taken into the pixel is formed by a pixel turn-on time period T1 and a threshold value control time period T2 for the switching elements Tr2. This embodiment differs from the first embodiment in a point that the threshold value control voltage Vr is taken from a third switching element Tr3. FIG. 11 shows an example of the equivalent circuit of one pixel of the display apparatus. One pixel is configured by at least three switching elements Tr1, Tr2, Tr3, a holding capacitor C1 and an organic EL element 201. The gate electrode of the switching element Tr1 is connected to a scanning line, the drain electrode thereof is connected to an image signal line, and the source electrode thereof is connected to the gate electrode of the switching element Tr2 and one end of the holding capacitor C1. The source electrode of the switching element Tr2 is grounded and the drain electrode thereof is connected to the cathode of the organic EL element 201. The gate electrode of the switching element Tr3 is connected to a threshold value control scanning line, the drain electrode thereof is connected to a threshold value control signal line, and the source electrode thereof is connected to the gate electrode of the switching element Tr2. In FIG. 11, although the one end of the holding capacitor C1 is grounded, the one end thereof may be connected to a turn-on control line La. The anode of the organic EL element is connected to the turn-on control line La and so applied with a constant voltage Va from a turn-on control power source.

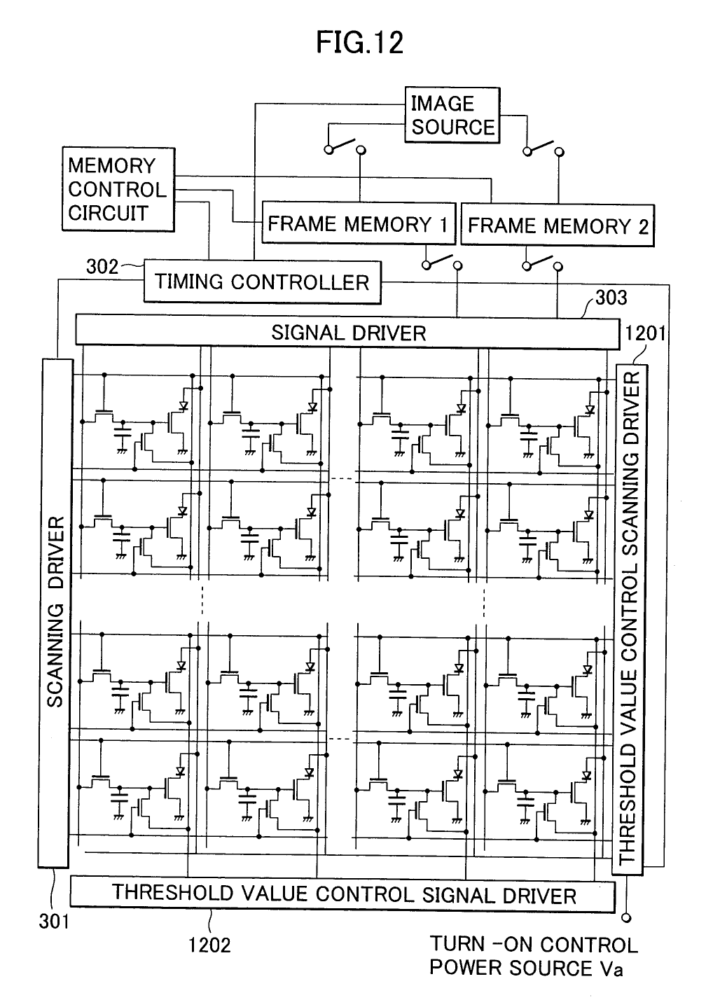

FIG. 12 shows an example of the entire system configuration of the display apparatus. In this system, the pixels disposed in rows and columns, the scanning line Lg for selecting the pixels with the predetermined cycle, the signal lines Ld for applying the luminance information to the pixels, the threshold value control scanning lines Lg_{T} for selecting the pixels with the predetermined cycle in order to control the threshold values, and the threshold value control signal lines Ld_{T} for applying the threshold value control signal are disposed in an matrix pattern. Each of the scanning line Lg is connected to a scanning driver 301 and a timing controller 302 is connected to the scanning driver 301. Each of the signal lines Ld is connected to a signal driver 303. Each of the threshold value control scanning lines Lg_{T} is connected to a threshold value control scanning driver 1201. Further, each of the threshold value control signal lines Ld_{T} is connected to a threshold value control signal driver 1202. The image information is taken into a frame memory 1 for display and a frame memory 2 for improving a threshold value, and the information thus taken into these memories is alternatively applied to the signal driver 303 and the threshold value control signal driver 1202.

When the scanning line of the n-th column connected to the pixel is selected, the corresponding switching element Tr1 is applied at its gate electrode with a predetermined voltage and so placed in an on state. At this time, the signal voltage Vs=Vdmn as the luminance information is taken from the signal line through the switching element Tr1. Even after the scanning line of the n-th column connected to the pixel is placed in a non-selection state, the luminance information thus taken is accumulated in the holding capacitor C1 of the pixel, so that the organic EL element is kept to illuminate during the pixel turn-on time period T1.

Next, when the threshold value control scanning line of the n-th column connected to the pixel is selected, the corresponding switching element Tr3 is applied at its gate electrode with a predetermined voltage and so placed in an on state. At this time, the threshold value control voltage Vr=Vdmn′ having opposite polarity to that at the time of turning-on of the pixel is taken from the threshold value control signal line and applied to the gate electrode of the switching element Tr2. Even after the threshold value control scanning line of the n-th column connected to the pixel is placed in a non-selection state, the threshold value control information thus taken is accumulated in the holding capacitor C1 of the pixel, so that the threshold value control voltage Vr is kept to be applied to the gate electrode of the switching element Tr2 during a predetermined time period.

When the threshold value control signal is fetched from the switching element Tr3, a pixel, in which the luminance information is fetched and so being turned on, can fetch the threshold value control information while the luminance information is fetched into another pixel. Thus, the number of writing can be increased as compared with the first embodiment.

Like the first embodiment, the threshold value control time period T2 of the switching element Tr2 is set to a half of the predetermined cycle from a time point of fetching the luminance information to a time point of fetching the next new luminance information, and the absolute value of the signal voltage Vs is set to be equal to the absolute value of the threshold value control voltage Vr.

In the case of setting the threshold value control time period T2 of the switching element Tr2 to be longer or shorter than a half of the predetermined cycle from a time point of fetching the luminance information to a time point of fetching the next new luminance information, the adjustment can be performed by the timing controller 302 attached to the scanning driver 301. Further, the threshold value control voltage Vr obtained by inverting the signal voltage Vs with respect to the shaft of the signal line voltage Vd=0 volt can be increased or decreased in its amplitude by the signal driver 303.

Although the value of the threshold value control voltage Vr desirably differs at every pixel, the threshold value control voltage Vr may set to be constant for all the pixels so long as the polarity of the threshold value control voltage Vr is in opposite to the signal voltage Vs.

In the case of displaying an image with monotone, since the signal voltage Vs which is almost the same value for all the pixels is taken, the threshold value control voltage Vr also becomes almost the same value for all the pixels.

(Fourth Embodiment)

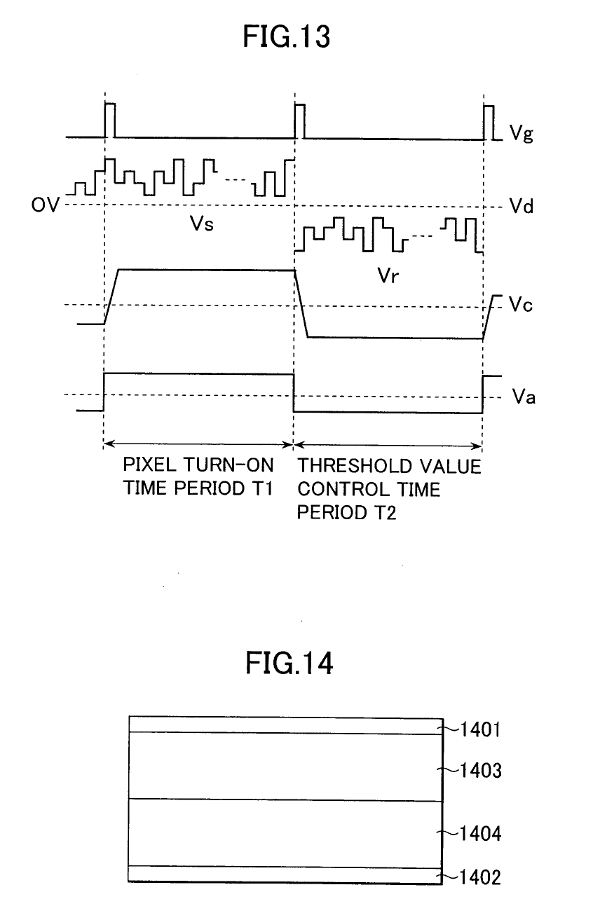

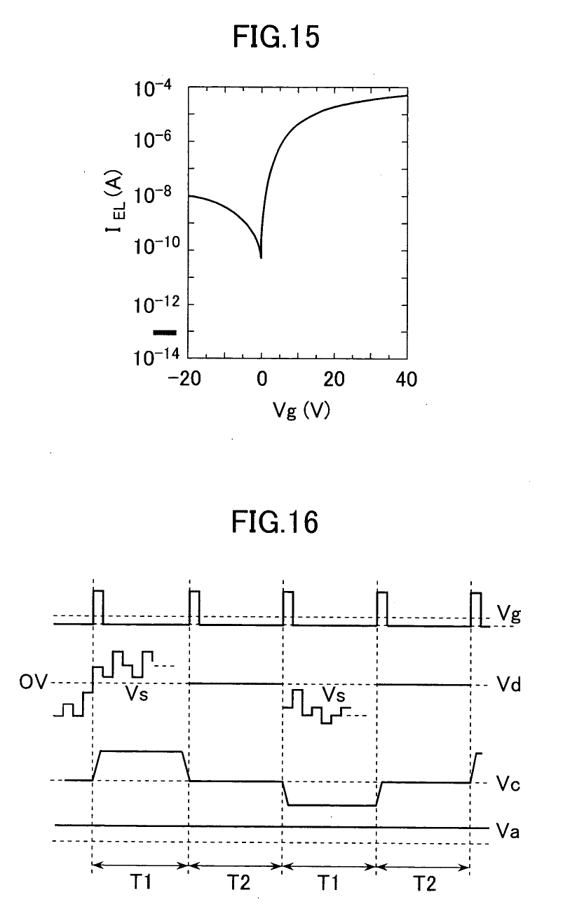

The fourth embodiment of the present invention will be explained with reference to FIGS. 2, 3 and 13 to 15. FIG. 13 shows voltage waveforms at respective wirings in this embodiment at the time of driving the display apparatus. A predetermined one cycle until next new luminance information is taken into a pixel after luminance information was taken into the pixel is formed by a pixel turn-on time period T1 and a threshold value control time period T2. This embodiment differs from the first embodiment in points that the threshold value shift caused at the pixel turn-on time period T1 is improved during the threshold value control time period T2 and that the electric field with opposite polarity to that at the time of turning-on of the pixel is also applied to the organic EL elements 201 to elongate the lifetime thereof.

An example of the equivalent circuit of one pixel of the display apparatus is same as that of FIG. 2. One pixel is configured by at least two switching elements Tr1, Tr2, a holding capacitor C1 and an organic EL element. The gate electrode of the switching element Tr1 is connected to a scanning line Lg, the drain electrode thereof is connected to an image signal line Ld, and the source electrode thereof is connected to the gate electrode of the switching element Tr2 and one end of the holding capacitor C1. The source electrode of the switching element Tr2 is grounded and the drain electrode thereof is connected to the cathode of the organic EL element 201. In FIG. 2, although the one end of the holding capacitor C1 is grounded, the one end thereof may be connected to a turn-on control line La. The anode of the organic EL element 201 is connected to the turn-on control line La.

The entire system configuration of the display apparatus is same as FIG. 3. The image information is taken into a frame memory 1 for display and a frame memory 2 for improving a threshold value, and the information thus taken into these memories is alternatively applied to the signal driver 303 and the threshold value control signal driver 1202.

For example, the pixel of the m-th row and the n-th column is operated during one cycle in the following manner. When the scanning line Lgn of the n-th column connected to the pixel is selected, the corresponding switching element Tr1 is applied at its gate electrode with a predetermined voltage and so placed in an on state. At this time, the signal voltage Vs=Vdmn as the luminance information is taken from the signal line Ld through the switching element Tr1 and then applied to the gate electrode of the switching element Tr2. Even after the scanning line Lgn of the n-th column connected to the pixel is placed in a non-selection state, the luminance information thus taken is accumulated in the holding capacitor C1 of the pixel, so that the signal voltage is kept to be applied for a predetermined period to the gate electrode of the corresponding switching element Tr2. Thus, since the constant voltage Va is applied to the anode of the organic EL element 201, the organic EL element 201 is kept to illuminate. Next, when the scanning line Lgn of the n-th column connected to the pixel is selected again, the corresponding switching element Tr1 is applied at its gate electrode with the predetermined voltage and so placed in the on state. At this time, the threshold value control voltage Vr=Vdmn′ is taken from the signal line Ld through the switching element Tr1 and then applied to the gate electrode of the switching element Tr2. Even after the scanning line Lgn of the n-th column connected to the pixel is placed in the non-selection state, the information thus taken is accumulated in the holding capacitor C1 of the pixel, so that the signal voltage is kept to be applied for the predetermined period to the gate electrode of the corresponding switching element Tr2. Further, the voltage of the negative polarity, for example, the voltage Va is applied to the electrode which has been the anode of the organic EL element 201, whereby this electrode of the organic EL element 201 becomes a cathode. In this manner, when the electric field of the negative polarity is applied to the organic EL element, the electric charges having been accumulated in the organic EL element when continuously being turned on can be removed and so the lifetime thereof can be elongated.

FIG. 14 shows a sectional diagram of the organic EL element. The organic EL element is configured in a manner that at least two organic layers of a hole transporting layer 1403 and an electron transporting layer 1404 (the organic layer may be one when the hole transporting layer and the electron transporting layer is common) are sandwiched between an anode 1401 and a cathode 1402. When the voltage is applied to the organic EL element in the forward direction, holes injected from the anode 1401 and electrons injected from the cathode 1402 are recombined within the organic light emitting layer and so light is emitted. The organic EL element 201 used actually may be formed by the organic layers further including a hole injection layer and an electron injection layer etc. In this case, in order to simplify the explanation, the explanation will be made as to the electric field applied to the organic EL element 201 in an example of the organic EL element using the two organic layers as shown in FIG. 14.

Supposing that the capacity of the hole transporting layer 1403 is Cₕ, the capacity of the electron tr ansporting layer 1404 is Cₑ, the thickness of the hole transporting layer 1403 is dₕ, the thickness of the electron transporting layer 1404 is dₑ, the resistance value of the organic EL element 201 is R_{OLED} and the resistance value of the switching element Tr2 is R_{Tr2}, the electric field Eₕ applied to the hole transporting layer 1403 of the organic E_{L} element and the electric field Ee applied to the electron transporting layer 1404 can be represented by the following expressions.

Eₕ={Cₑ/(Cₕ+Cₑ)}{R_{OLED}/(R_{OLED}+R_{Tr2})}dₕ (1)

Eₑ={Cₕ/(Cₕ+Cₑ)}{R_{OLED}/(R_{OLED}+R_{Tr2})}dₑ (2)

It is desirable that the organic EL element 201 is a diode and a current value with respect to the voltage of the reverse polarity is less than 10⁻⁸ A/cm². When this current value is converted, the current of about 2×10⁻¹² A flows in the display apparatus with about 100 ppi. In the a-Si thin film transistor of the first embodiment, for example, as shown in FIG. 5, only a current in the order of 10⁻¹³ A flows when the threshold value control voltage Vr is applied. That is, when the a-Si thin film transistor of the first embodiment is used in this embodiment, the resistance value R_{Tr2 of the switching element Tr2 becomes larger than the resistance value R}_{OLED} of the organic EL element by the order of one digit. Thus, the value of the R_{OLED}/(R_{OLED}+R_{Tr2}) shown in the expressions (1) and (2) becomes small and so the electric field can not be effectively applied to the hole transporting layer 1403 and the electron transporting layer 1404 of the organic EL element.

In order to effectively apply the electric field of the reverse polarity to the organic EL element 201 during the threshold value control time period T2, the current flowing through the switching element Tr2 at the time of applying the threshold value control voltage Vr is required to be made at least larger than the current of about 2×10⁻¹² A flowing in the organic EL element 201.

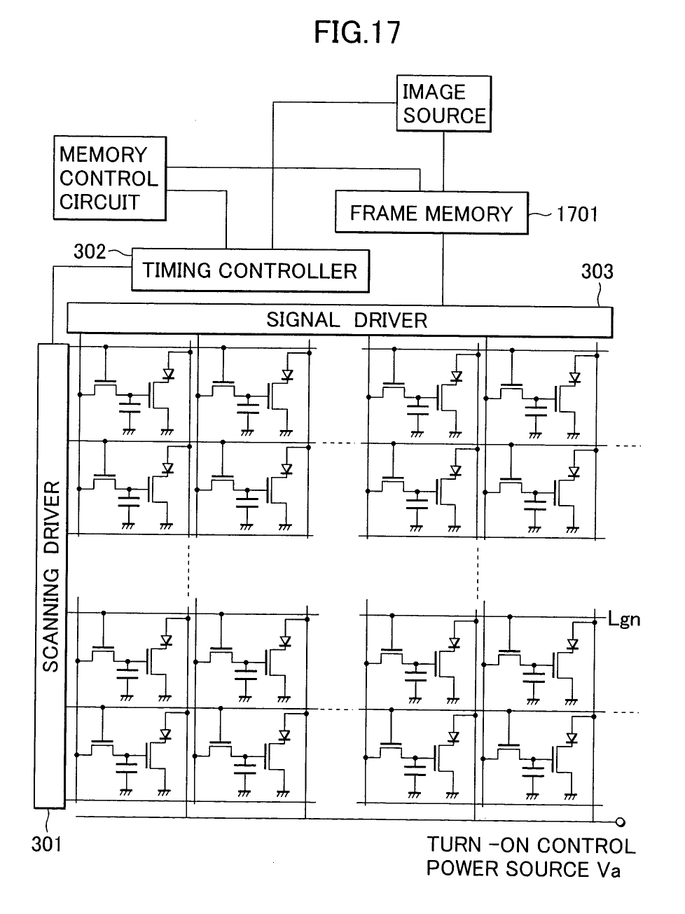

Thus, in this embodiment, an a-Si thin film transistor having no n⁺ contact layer or having an n⁺ contact layer being made thin so as to have a thickness of 10nm or less or is used as the switching element Tr2. FIG. 17 shows the switching characteristics of a bottom gate type a-Si thin film transistor having no n+ contact layer. When the n+ contact layer is eliminated or the n+ contact layer is made thin so as to have the thickness of 10 nm or less, the holes are transferred as carriers in the region where the gate voltage is negative and so a current in the order of 10^{-11 to -8} flows in the switching element Tr2.

The thin film transistor used as the switching element Tr2 may use smectic liquid crystal etc. having a relatively high mobility (1×10⁻² cm²/Vs or more) in each of hole and electron, for example, as the semiconductor layer.

(Fifth Embodiment)

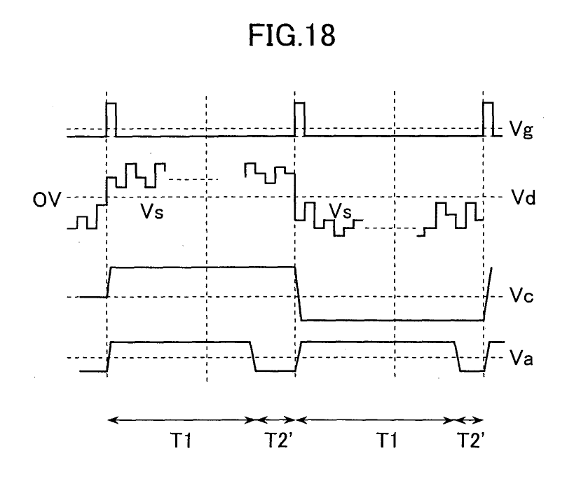

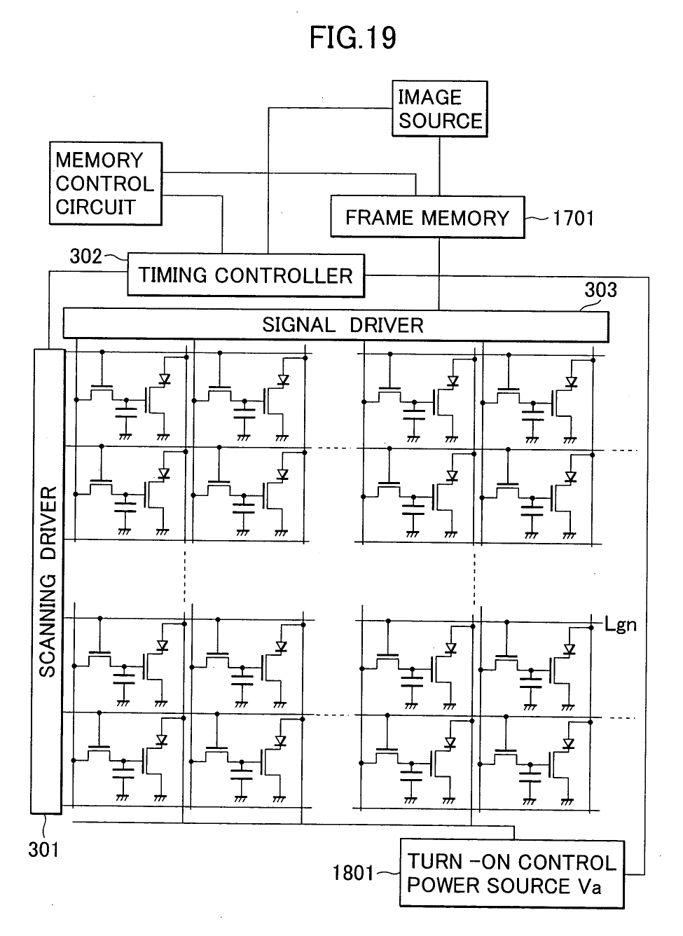

The fifth embodiment of the present invention will be explained with reference to FIGS. 18 and 19. FIG. 18 shows voltage waveforms at respective wirings in this embodiment at the time of driving the display apparatus. A predetermined one cycle until next new luminance information is taken into a pixel after luminance information was taken into the pixel is formed by a pixel turn-on time period T1 and a pixel turn-off time period T2′. The luminance information taken into a pixel from the signal line differs in its polarity at every cycle. This embodiment differs from the first to fourth embodiments in a point that the threshold value shift of the thin film transistor caused during the pixel turn-on time period of a cycle is improved in the next pixel turn-on time period.

An example of the equivalent circuit of one pixel of the display apparatus is same as the conventional example shown in FIG. 2.

FIG. 19 shows an example of the entire system configuration of the display apparatus. In this system, the pixels disposed in rows and columns, the scanning line Lg for selecting the pixels with the predetermined cycle, and the signal lines Ld for applying the luminance information to the pixels are disposed in an matrix pattern. Each of the scanning line Lg is connected to a scanning driver 301 and a timing controller 302 is connected to the scanning driver 301. Each of the signal lines Ld is connected to a signal driver 303. The image information is taken into a frame memory 1901 and the information thus taken into the memory is applied to the signal driver 303.

For example, the pixel of the m-th row and the n-th column is operated during one cycle in the following manner. When the scanning line Lgn of the n-th column connected to the pixel is selected, the corresponding switching element Tr1 is applied at its gate electrode with a predetermined voltage and so placed in an on state. At this time, the signal voltage Vs=Vdmn as the luminance information is taken from the signal line Ld through the switching element Tr1 and then applied to the gate electrode of the switching element Tr2. Even after the scanning line Lgn of the n-th column connected to the pixel is placed in a non-selection state, the luminance information thus taken is accumulated in the holding capacitor C1 of the pixel, so that the organic EL element 201 is kept to illuminate for a predetermined time period.

Next, when the scanning line Lgn of the n-th column connected to the pixel is selected again, a turn-off voltage V_{OFF} is taken through the corresponding switching element Tr1 and so the corresponding switching element Tr2 is placed in an off state. Even after the scanning line Lgn of the n-th column connected to the pixel is placed in a non-selection state, the luminance information is accumulated in the holding capacitor C1 of the pixel, so that the organic EL element 201 is kept in the off state for a predetermined time period.

At the next one cycle, when the scanning line Lgn of the n-th column connected to the pixel is selected again, a signal voltage Vs=−Vdmn′ having the opposite polarity to that of the previous cycle is taken through the corresponding switching element Tr1 from the signal line Ld and so the organic EL element 201 is kept to illuminate for a predetermined time period.

Next, when the scanning line Lgn of the n-th column connected to the pixel is selected again, similarly, the turn-off voltage V_{OFF} is taken through the corresponding switching element Tr1 and so the corresponding switching element Tr2 is placed in an off state, so that the organic EL element 201 is kept in the off state for the predetermined time period.

In the switching element Tr2 used in this embodiment, it is necessary to transfer both holes and electrons as carriers.

Thus, in this embodiment, like the fourth embodiment, an a-Si thin film transistor having no n⁺ contact layer or having an n⁺ contact layer being made thin so as to have the thickness of 10 nm or less may be used as the switching element Tr, or a thin film transistor using smectic liquid crystal etc. having a relatively high and equal mobility in each of hole and electron as the semiconductor layer may be used as the switching element Tr2.

As shown in FIGS. 18 and 19, the organic EL element may be applied with the reverse electric field by a turn-on control power source 1801 thereby to control the pixel turn-off time period T2′. In this case, like the fourth embodiment, the switching element Tr2 may be kept in an on state also during the pixel turn-off time period T2′ so as to elongate the lifetime of the organic EL element 201.

The pixel turn-off time period T2′ can be controlled freely by attaching the timing controller 302 to the turn-on control power source 1801.

Like the third embodiment, in the same fetching manner of the threshold value control voltage into a pixel, the third switching elements may be provided so as to fetch the turn-off voltage V_{OFF} to be applied to the gate electrodes of the switching elements Tr2 through the third switching elements.

Further, the pixel turn-off time period T2′ may not be provided.

According to the present invention, the display apparatus driven by DC current with a large screen, in which the threshold value shift of the switching element for a pixel is controlled and an amorphous silicon thin film transistor and an organic thin film transistor is used as the switching element for a pixel, can be provided at a low cost.

What is claimed is:

1. In a display apparatus driven by DC current in which signal lines for applying luminance information to each of pixels, scanning lines for selecting the pixels to be applied with the luminance information are disposed in an matrix pattern; each of the pixels includes a light emitting element for emitting light in response to a current flowing therein, a first switching element for fetching the luminance information into corresponding one of the pixels from corresponding one of the signal lines, and a second switching element for controlling a current amount to be supplied to corresponding one of the light emitting elements in accordance with the luminance information thus fetched; the luminance information is fetched into each of the pixels by fetching a signal voltage of corresponding one of the signal lines when corresponding one of the scanning lines connected to the pixel is selected; and the luminance information thus fetched in each of the pixels is kept in corresponding one of capacitors even after the corresponding one of the scanning lines connected to the pixel is place in a non-selection state, wherein
a predetermined one cycle until next new luminance information is taken into each of the pixels after luminance information was taken into the pixel is formed by a pixel turn-on time period and a threshold value control time period for applying a threshold value control voltage having an opposite polarity to that of a signal voltage as the luminance information to the gate electrode of the corresponding one of the second switching elements.

2. A display apparatus driven by DC current according to claim 1, wherein the threshold value control voltage applied to the gate electrode of each of the second switching elements is fetched through the corresponding one of the first switching elements from the corresponding one of the signal lines.

3. A display apparatus driven by DC current according to claim 1, wherein each of the pixels further includes a third switching element, and the threshold value control voltage applied to the gate electrode of each of the second switching elements is fetched through the corresponding one of the third switching elements from the corresponding one of the signal lines.

4. A display apparatus driven by DC current according to claim 1, further comprises two image memories.

5. A display apparatus driven by DC current according to claim 1, wherein the threshold value control voltage applied to the gate electrode of each of the second switching elements is obtained by inverting polarity of the signal voltage of the same cycle.

6. A display apparatus driven by DC current according to claim 1, wherein the threshold value control time period for applying the threshold value control voltage to the gate electrode of each of the second switching elements is about a half of the predetermined cycle until next new luminance information is taken into corresponding one of the pixels after luminance information was taken into the corresponding one of the pixels.

7. A display apparatus driven by DC current according to claim 1, wherein a semiconductor layer of each of the second switching elements is formed by amorphous silicon.

8. In a display apparatus driven by DC current in which signal lines for applying luminance information to each of pixels, scanning lines for selecting the pixels to be applied with the luminance information are disposed in an matrix pattern; each of the pixels includes a light emitting element for emitting light in response to a current flowing therein, a first switching element for fetching the luminance information into corresponding one of the pixels from corresponding one of the signal lines, and a second switching element for controlling a current amount to be supplied to corresponding one of the light emitting elements in accordance with the luminance information thus fetched; the luminance information is fetched into each of the pixels by fetching a signal voltage of corresponding one of the signal lines when corresponding one of the scanning lines connected to the pixel is selected; and the luminance information thus fetched in each of the pixels is kept in corresponding one of capacitors even after the corresponding one of the scanning lines connected to the pixel is place in a non-selection state, wherein
a predetermined one cycle until next new luminance information is taken into each of the pixels after luminance information was taken into the pixel is formed by a pixel turn-on time period and a time period for applying to corresponding one of the light emitting elements electric field with opposite polarity to electric field applied during the pixel turn-on time period and also for applying a threshold value control voltage having an opposite polarity to that of a signal voltage as the luminance information to the gate electrode of the corresponding one of the second switching elements.

9. A display apparatus driven by DC current according to claim 8, wherein the threshold value control voltage applied to the gate electrode of each of the second switching elements is fetched through the corresponding one of the first switching elements from the corresponding one of the signal lines.

10. A display apparatus driven by DC current according to claim 8, wherein each of the pixels further includes a third switching element, and the threshold value control voltage applied to the gate electrode of each of the second switching elements is fetched through the corresponding one of the third switching elements from the corresponding one of the signal lines.

11. A display apparatus driven by DC current according to claim 8, further comprises two image memories.

12. A display apparatus driven by DC current according to claim 8, wherein the threshold value control voltage applied to the gate electrode of each of the second switching elements is same for each of the pixels.

13. A display apparatus driven by DC current according to claim 8, wherein the threshold value control time period for applying the threshold value control voltage to the gate electrode of each of the second switching elements is about a half of the predetermined cycle until next new luminance information is taken into corresponding one of the pixels after luminance information was taken into the corresponding one of the pixels.

14. A display apparatus driven by DC current according to claim 8, wherein each of an electric field effect mobility of holes and an electric field effect mobility of electrons in a semiconductor layer of each of the second switching elements is 1×10⁻² cm²/Vs or more.

15. A display apparatus driven by DC current according to claim 8, wherein a semiconductor layer of each of the second switching elements includes amorphous silicon, and no n⁺ contact layer is contained between the semiconductor layer and source and drain electrodes thereof.

16. A display apparatus driven by DC current according to claim 8, wherein a semiconductor layer of each of the first and second switching elements includes amorphous silicon, and a n+ contact layer disposed between the semiconductor layer and source and drain electrodes thereof is thinner in thickness than a n* contact layer of each of the first switching elements.

17. A display apparatus driven by DC current according to claim 8, wherein a semiconductor layer of each of the second switching elements is formed by organic.

18. A display apparatus driven by DC current according to claim 8, wherein each of the light emitting elements is an organic electroluminesence element.

19. In a display apparatus driven by DC current in which signal lines for applying luminance information to each of pixels, scanning lines for selecting the pixels to be applied with the luminance information are disposed in an matrix pattern; each of the pixels includes a light emitting element for emitting light in response to a current flowing therein, a first switching element for fetching the luminance information into corresponding one of the pixels from corresponding one of the signal lines, and a second switching element for controlling a current amount to be supplied to corresponding one of the light emitting elements in accordance with the luminance information thus fetched; the luminance information is fetched into each of the pixels by fetching a signal voltage of corresponding one of the signal lines when corresponding one of the scanning lines connected to the pixel is selected; and the luminance information thus fetched in each of the pixels is kept in corresponding one of capacitors even after the corresponding one of the scanning lines connected to the pixel is place in a non-selection state, wherein
a signal voltage as the luminance information to be fetched into each of the pixels differs in its polarity at every cycle.

20. A display apparatus driven by DC current according to claim 19, wherein during the one cycle until next new luminance information is taken into each of the pixels after luminance information was taken into the pixel, a time period for turning off corresponding one of the second switching elements thereby to turn off corresponding one of the pixels.
